(19) United States
(12) Patent Application Publication
(10) Pub. No.: US 2024/0086776 A1
(43) Pub. Date: Mar. 14, 2024

(54) CLOSED-LOOP ONLINE SELF-LEARNING FRAMEWORK APPLIED TO AUTONOMOUS VEHICLE

(71) Applicant: TONGJI UNIVERSITY, Shanghai (CN)

(72) Inventors: Yanjun HUANG, Shanghai (CN); Shuo YANG, Shanghai (CN); Xincheng LI, Shanghai (CN); Hong CHEN, Shanghai (CN)

(21) Appl. No.: 18/513,241

(22) Filed: Nov. 17, 2023

(30) Foreign Application Priority Data
May 22, 2023 (CN) 202310581929.7

(51) Int. Cl. G06N 20/00

(52) U.S. Cl. CPC G06N 20/00

(57) ABSTRACT

The present invention provides a closed-loop online self-learning framework applied to an autonomous vehicle, and belongs to the technical field of automatic driving. The closed-loop online self-learning framework includes five data closed loop links, including: an Over-the-Air Technology (OTA) closed loop, an online learning closed loop, an algorithm evolution closed loop, a self-adversarial improvement closed loop, and a cloud coevolution closed loop. According to current characteristics of a self-evolution process of an algorithm, the five data closed loop links of the present disclosure are subjected to overall management through a logical switching layer of an upper layer, so as to separate a self-evolution algorithm from a typical machine learning flow, and closed-loop online self-learning of an automatic driving algorithm is achieved under a rapidly changing scenario by fully using an advanced artificial intelligence and automatic driving technology, so as to finally achieve closed-loop evolution of an automatic driving algorithm.

### CROSS-REFERENCE TO RELATED APPLICATIONS

This application claims the benefit of priority from Chinese Patent Application No. 202310581929.7, filed on May 22, 2023. The content of the aforementioned application, including any intervening amendments thereto, is incorporated herein by reference in its entirety.

### TECHNICAL FIELD

The present invention belongs to the technical field of automatic driving, and particularly, to a closed-loop online self-learning framework applied to an autonomous vehicle.

### BACKGROUND OF THE INVENTION

Automatic driving is a reflection of cross fusion of the automobile industry and a new-generation information technology such as artificial intelligence, automatic control, and big data in the traffic field. A high-grade automatic driving system can cope with almost all complex traffic environments and complete driving tasks safely and efficiently. The degree of intelligence of an algorithm is a major bottleneck that limits large-scale implementation of fully automatic driving. However, although mainstream logic rule-based algorithms have clearer and more reliable frameworks, it is very difficult for artificial design rules to cover most automatic driving operation scenarios, especially in complex and unknown scenarios.

In recent years, a self-evolution algorithm taking experience storage and learning upgrade as a core idea attracts more and more attentions, and the development of an automatic driving technology starts to be promoted. It can be seen that an automatic driving algorithm with safe online self-evolution capability has the potential to adapt to infinite scenarios in the real world, so as to greatly reduce a quantity of accidents.

However, the current self-evolution method has not been separated from a typical machine learning flow, and advanced artificial intelligence and automatic driving technologies cannot be fully used, so that closed-loop online self-learning of the automatic driving algorithm is achieved in fast changing scenarios.

### SUMMARY

The present invention aims to provide a closed-loop online self-learning framework applied to an autonomous vehicle, including five data closed loop links, wherein the five data closed loop links comprise an Over-the-Air Technology (OTA) closed loop, an online learning closed loop, an algorithm evolution closed loop, a self-adversarial improvement closed loop, and a cloud coevolution closed loop.

According to current characteristics of a self-evolution process of an algorithm, the five data closed loop links of the present disclosure are subjected to overall management through a logical switching layer of an upper layer, finally achieving closed-loop evolution of an automatic driving algorithm.

Further, the OTA closed loop is specifically as follows: a vehicle side of the autonomous vehicle transmits a large amount of data collected by a sensor to a cloud side, and an algorithm engineer extracts and arranges the large amount of data collected and conducts model training and test evaluation; and after the acquired data achieves phased promotion of the algorithm, a technician updates the version and deploys a new model.

Further, the online learning closed-loop is as follows: during practical applications of the algorithm, in each step, data entering in a continuous sequence is used to carry out learning update; the online learning closed-loop specifically comprises model training and test evaluation; a quantification evaluation result of a self-evolution capability, namely, algorithm performance, is obtained through the test evaluation;
when the algorithm performance is not improved to generalized learning convergence, the online learning closed loop is switched to the algorithm evolution closed loop to achieve further evolution of the algorithm; and
when the algorithm performance is improved to the generalized learning convergence, the online learning closed loop is switched to the self-adversarial improvement closed loop.

Further, the algorithm evolution closed loop achieves further evolution of the algorithm performance by adjusting hyperparameters of the learning algorithm and structural parameters of a neural network, and is switched to the online learning closed loop of a next round.

Further, the self-adversarial improvement closed loop is represented as follows: the autonomous vehicle runs in a real world and a virtual world simultaneously, and copes with real and virtual traffic scenarios, specifically comprising the following steps:
S1: determining, through comprehensive evaluation of scenario task complexity and algorithm performance quantification, whether a current scenario exceeds an operational design domain of the automatic driving algorithm;
S2: performing parametric designing on a scenario to obtain a parametric representation of scenario reconstruction;
S3: generating an adversarial scenario on the basis of an enhanced learning method or an adversarial learning method, and injecting the adversarial scenario into a virtual scenario generation library;
S4: combining the virtual scenario generation library, a typical standard data set, and vehicle field test data to form a data set library; and
S5: achieving an adversarial-enhanced data closed loop on the basis of the data set library by means of a virtuality and reality combination technology.

Further, the self-adversarial improvement closed loop closes data to a real vehicle operation level through an automatic scenario reconstruction technology and a data marking technology on the basis of characteristics of a real world and characteristics of virtual simulation;
the real world comprises improving the performance of collecting perception data and driving a perception algorithm, and supplementation and enrichment of the data set library are achieved by recognizing and capturing an edge scenario;
the virtual simulation is used for generating the adversarial scenario, and better reasonable coping is achieved by training an automatic driving decision-making and planning algorithm in real time;
in a framework of the self-adversarial improvement closed loop, an automatic driving system makes a response to more real scenarios by gradually expanding the operational design domain safely, to update virtual-real transparency in real time until a scenario where the virtual simulation is completely closed is generated; and a final aim of safe automatic driving in the real world is thus achieved.

Further, the cloud coevolution closed loop provides a multi-vehicle fast coevolution framework comprising a combined model training policy and a combined or local model update policy, thereby achieving cloud coevolution shared with efficient training resources.

Compared with the prior art, the present invention has the following beneficial effects: The present invention separates the self-evolution algorithm from the typical machine learning flow, and achieves the closed-loop online self-learning of the automatic driving algorithm under the fast changing scenarios by fully using the advanced artificial intelligence and automatic driving technologies, thereby finally achieving the purpose of safe automatic driving in the real world.

### BRIEF DESCRIPTION OF THE DRAWINGS

FIG. 1 is a flowchart of a closed-loop online self-learning framework applied to an autonomous vehicle according to the present invention.

### DETAILED DESCRIPTION

A more detailed description will now be made below to a closed-loop online self-learning framework applied to an automatic driving vehicle according to the present invention in conjunction with the schematic drawings, which represents preferred embodiments of the present invention. It should be understood that a person skilled in the art can modify the present invention described herein while still achieving the advantageous effects of the present invention. Therefore, the following description should be understood as being widely known to a person skilled in the art and not as limiting the present invention.

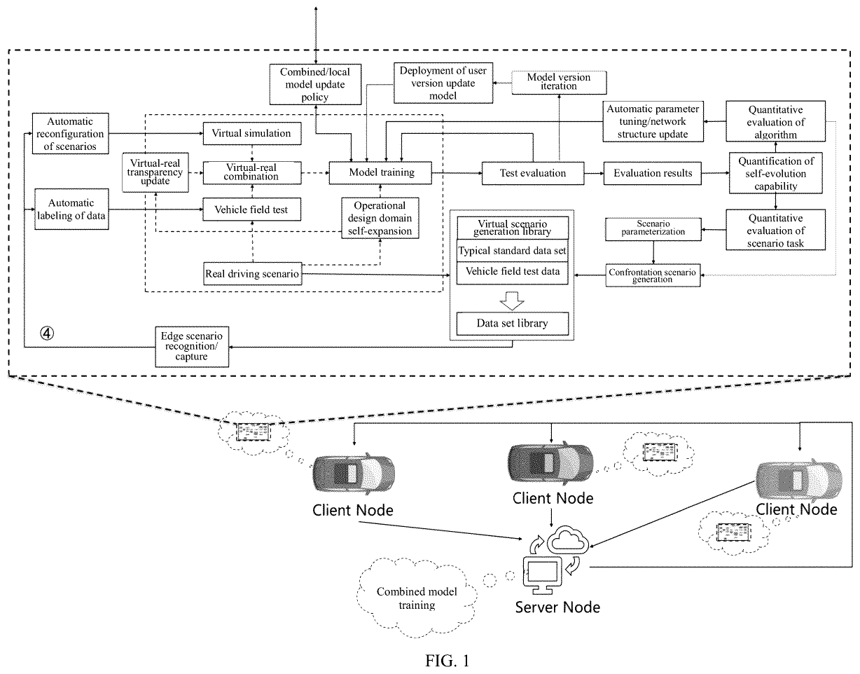

As shown in FIG. 1, a closed-loop online self-learning framework applied to an autonomous driving vehicle is composed of five data closed loop links, specifically including the following:

I: An OTA Closed Loop.

The OTA can upgrade software online through a cloud server, so as to update the version of an automatic driving algorithm. A standard flow of the OTA closed loop is as follows: A vehicle side of the autonomous vehicle transmits a large amount of data collected by a sensor to a cloud side, and an algorithm engineer extracts and processes the large amount of data collected and conducts model training and test evaluation. After enough data is acquired and the performance of a certain stage is improved, a technician can update a user version and deploy a new model. This data closed loop link will play a more important role in an initial stage of closed-loop iteration and self-evolution. Initial fast evolution can be achieved through an experienced engineer, thus obtaining an available initial performance.

II: Online Learning Closed Loop.

A core idea of online learning is that during practical application of the algorithm, in each step, data entering in a continuous sequence is used to carry out learning update. The online learning is not a specific machine learning method, but a learning paradigm of an algorithm. Both supervised learning and enhanced learning can be well compatible in an online learning framework and play their key role in this closed loop link. The core of the closed loop link includes model training and test evaluation. They are also a basic framework of the online learning.

III: Algorithm Evolution Closed Loop.

An evolution direction is determined by means of a quantification evaluation result of the self-evolution capability. The core idea of the data link is as follows: Further evolution of the algorithm performance is achieved by adjusting hyperparameters of the learning algorithm and structural parameters of a neural network. The key to achieve this step is to quantify the self-evolution capability to determine whether the closed loop link is switched from the online learning closed loop to the algorithm evolution closed loop. If the performance of the learning algorithm is improved to a certain degree, namely, if generalized learning convergence is achieved, the algorithm performance is continuously quantitatively evaluated, so as to guide achievement of automatic parameter adjustment and update of a network structure, thus entering the online learning closed loop of a next round.

IV: Self-Adversarial Improvement Closed Loop.

Through the complete online learning closed loop and algorithm evolution closed loop, the algorithm performance has been improved to a capability to basically cope with a current complex scenario. Under the evaluation of self-evolution capability quantification, the self-adversarial improvement closed loop will be switched in. The core idea of the data link is that when the automatic driving algorithm can cover a scenario with a certain difficulty, a scenario with a higher difficulty is generated according to the self-adversarial idea, so as to guide the algorithm to be further evolved to achieve expansion of the operational design domain. Such antagonism is continuous and can achieve a spiral improvement in the algorithm performance. Important essential links under the framework described above are scenario task complexity quantification evaluation, parameterization and reconstruction of a scenario, and generation of an adversarial scenario.

The scenario task complexity quantification evaluation specifically refers to quantitative evaluation of the complexity of a current scenario. Generally, a more complex road topology of a scenario indicates a large quantity of surrounding traffic participants, higher uncertainty, a more complex environment, and higher scenario task complexity. The opportunity and direction of upgrade of the difficulty of the adversarial scenario can be guided only when the scenario complexity is quantified. The parameterization and reconstruction of a scenario mean that a mapping relationship between complex scenario generation parameters and the scenario itself is found. It is a basis in a subsequent adversarial scenario generation framework, namely, a complete data closed loop can be achieved in an adversarial scenario generation process only when the parameterization and reconstruction of a scenario are achieved. An enhanced learning framework is used in the adversarial scenario generation. A parameterized value of the scenario is used as an action, and a comprehensive algorithm performance quantification evaluation value and a scenario complexity quantification evaluation value are used as rewards, namely, a certain group of scenario is found. The algorithm performance reaches a limit in the scenario, and the corresponding scenario is a self-adversarial scenario required in the data link.

A flow of the self-adversarial improvement closed loop data link is as follows: Firstly, comprehensive evaluation of scenario task complexity and algorithm performance quantification is performed to determine whether a current scenario exceeds an operational design domain of the automatic driving algorithm. (If yes, the self-adversarial improvement closed loop). Parametric designing is then performed on a scenario to obtain a parametric representation of scenario reconstruction. Afterwards, an adversarial scenario is generated on the basis of an enhanced learning method or an adversarial learning method, and the adversarial scenario s injected into a virtual scenario generation library. The virtual scenario generation library, a typical standard data set, and vehicle field test data are combined to form a data set library, and an adversarial-enhanced data closed loop is achieved by means of a virtuality and reality combination technology. Specifically, the autonomous vehicle runs in a real world and a virtual world simultaneously, and copes with real and virtual traffic scenarios.

Data is closed to a real vehicle operation level through an automatic scenario reconstruction technology and a data marking technology according to characteristics of a real world and characteristics of virtual simulation. The real world part mainly collects perception data and drives the performance of a perception algorithm to be improved. Because a real vehicle operation scenario has the highest authenticity, and meanwhile, the data set library is supplemented and enriched by recognizing and capturing an edge scenario. In the virtual simulation part, since the safety under the virtual simulation can be guaranteed, the method is used for generating an adversarial scenario and training an automatic driving decision-making and planning algorithm in real time to better and reasonably cope with the adversarial scenario. In the framework of the self-adversarial improvement closed loop, an automatic driving system can make a response to more real scenarios by gradually expanding the operational design domain safely, so that virtual-real transparency can be updated in real time until a scenario where the virtual simulation is completely closed is generated; and a final aim of safe automatic driving in the real world can be achieved.

V: Cloud Coevolution Closed Loop.

Federated learning is a distributed machine learning technology, and aims to achieve co-learning on the basis of ensuring data privacy and security and legal compliance, so as to improve the effect of an AI model. For large-scale implementation of the automatic driving algorithm, how to realize co-improvement of the performance of multiple vehicles on the premise of ensuring privacies of users is an important part which needs to be considered. The cloud coevolution closed loop link provides a multi-vehicle fast coevolution framework including a combined model training policy and a combined/local model update policy, so as to achieve cloud coevolution shared with efficient training resources.

### Embodiment

In a typical automatic driving scenario, a closed-loop self-learning framework provided by the present invention can be verified to fully illustrate its application potential. A longitudinal following scenario is taken as an example. In the scenario, an autonomous vehicle is required to automatically control a speed to reduce energy loss and ensure comfort while completing a safe following task.

Online learning closed-loop stage: In this stage, an intelligent agent performs accelerates and decelerates a vehicle through longitudinal control, and policies are updated by aiming at obtaining higher rewards. An enhanced learning question is modeled as follows:

Actuating quantity: In order to prevent performance loss due to a sudden change in an acceleration of the vehicle, a controlled quantity is set to be a change rate of a longitudinal acceleration, that is, a=Δaₓ. An actual acceleration a_{x_tar} at each time may be represented as a_{x_tar}=a_{x_tar}=a_{x_last}+a, where a_{x_last} is an actual acceleration of the vehicle at a previous moment.

Observed quantity: In order to enable the intelligent agent to know information in a surrounding environment, the observed quantity needs to be designed. The observed quantity is set to be s=[Dₓ, Dᵥ, vₓ, aₓ], where Dₓ is a relative distance between the vehicle and a front vehicle; Dᵥ is a relative speed between the vehicle and the front vehicle; vₓ is a speed of the vehicle; and aₓ is an acceleration of the vehicle.

Reward: A reward function is directly related to an upgrading direction of a self-evolution algorithm, so the reward design is very important for the online learning algorithm. For an automatic speed control task of automatic driving, five reward functions are designed: 1. a speed reward rₛ, which encourages the vehicle to enter a driving state as soon as possible and to run at a higher speed as much as possible within a proper speed range; 2. a collision punishment r_{c}, which punishes any collision behavior, so as to ensure the safety of the autonomous vehicle; 3. a following distance punishment r_{d}, which prevents the vehicle from being too close to the front vehicle and encourages the vehicle to keep a proper distance while following the front vehicle; 4. an acceleration limit punishment rₐ, which prevents the vehicle from generating large acceleration longitudinally, thereby affecting the ride experience of a driver and damaging the performance of an actuating mechanism; and 5. an acceleration jerk limit punishment rⱼ, which reduces an acceleration jerk as much as possible, so as to improve the ride comfort of the vehicle. An overall reward function is defined as: r=rₛ+r_{c}+r_{d}+rₐ+rⱼ.

The training process is performed in a high-fidelity simulator.

Self-adversarial closed loop stage: In the self-adversarial closed-loop stage, the difficulty of the surrounding traffic environment is increased, so as to force the performance of the vehicle to be further evolved. In this case study, the front vehicle is an important part of the scenario, and is subjected to speed control for antagonism with the vehicle. Under a new paradigm of self-evolution, this stage is composed of several parts below:

Scenario parameterization: The scenario parameterization is a basis for the generation of an adversarial scenario. The scenario parameterization means that a mapping relationship is designed, and one representative scenario or a class of representative scenarios can be obtained according to the mapping through a group of parameters. In this case study, it is designed herein that the speed of the front vehicle is v_{scenario}=λ(vₘₐₓ−vₘᵢₙ)+vₘᵢₙ, where vₘᵢₙ and vₘₐₓ are an upper limit and a lower limit of the speed, and is defined as a scenario parameter. Through the adjustment of λ, the vehicle following scenario can be controlled.

Generation of an adversarial scenario: The adversarial scenario is a traffic scenario that may degrade the performance of the vehicle. In order to find parameters of the adversarial scenario, an enhanced learning question is constructed herein to obtain a parameter value λ of the adversarial scenario by taking minimization of the performance of the intelligent agent of the vehicle as a reward design. For unified consideration, an observed quantity of the enhanced learning algorithm is designed to be consistent with the observed quantity of the learning algorithm involved in the online learning closed-loop stage, and an action of the enhanced learning algorithm is set to be a scenario parameter λ, which is an action value.

Data set library & scenario complexity quantification: The scenario parameters generated by antagonism are summarized in the data set library, as shown in the figures. The abscissa represents a quantity of steps of a round, and the ordinate is a quantity of rounds in the self-adversarial process. The coordinate axis on the right hand side is a reward growth curve in the antagonism process of the front vehicle, and a quantification index can be provided for the scenario complexity through the curve. In order to enable the driving intelligent agent to carry out self-evolution under a scenario with a higher difficulty and ensure the generalization of the scenario, in this case study, the last 40% of scenario parameter sequences λ(t) are randomly sampled and played back.

Automatic scenario reconstruction: The scenario parameter sequences sampled from a data set library are used to perform the automatic scenario reconstruction. Specifically, the front vehicle controls a longitudinal speed of the vehicle according to the randomly sampled scenario parameter sequences λ*(t). For the vehicle, it is harder for the driving intelligent agent to obtain a reward due to the motion of the front vehicle, so that targeted training on the driving intelligent agent can effectively improve the performance of the automatic driving system.

The above descriptions are only preferred embodiments of the present invention and are not intended to make any limitation on the present invention. Any person skilled in the art can make any equivalent substitutions, modifications, or other changes on the technical solutions and technical contents disclosed in the present invention without departing from the scopes of the technical solutions of the present invention, and the equivalent substitutions, modifications, or changes do not depart from the contents of the technical solutions of the present invention and still fall within the protection scope of the present invention.

What is claimed is:

1. A closed-loop online self-learning architecture applied to an autonomous vehicle, comprising five data closed-loop links, wherein the five data closed-loop links include an Over-the-Air Technology (OTA) closed loop, an online learning closed loop, an algorithm evolution closed loop, a self-adversarial improvement closed loop, and a cloud coevolution closed loop, wherein according to current characteristics of a self-evolution process of an algorithm, the five data closed-loop links are subjected to overall management through an upper logical switching layer, finally achieving closed-loop evolution of an automatic driving algorithm.

2. The closed-loop online self-learning architecture applied to an autonomous vehicle according to claim 1, wherein the OTA closed loop specifically involves: a vehicle side of the autonomous vehicle transmitting a large amount of data collected by a sensor to a cloud side; an algorithm engineer extracting and organizing the large amount of data collected for model training and test evaluation; and after achieving phased improvement of the algorithm through the acquired data, a technician performing a version update and deploying a new model.

3. The closed-loop online self-learning architecture applied to an autonomous vehicle according to claim 1, wherein the online learning closed loop involves: using sequential incoming data for learning and updates at each step during practical applications of the algorithm; the online learning closed loop specifically comprises two parts which are model training and test evaluation, wherein a quantitative evaluation result of self-evolution capability, namely algorithm performance, is obtained through the test evaluation;
when the algorithm performance has not improved to generalized learning convergence, the online learning closed loop switches to the algorithm evolution closed loop to achieve further evolution of the algorithm;
when the algorithm performance has improved to the generalized learning convergence, the online learning closed loop switches to the self-adversarial improvement closed loop.

4. The closed-loop online self-learning architecture applied to an autonomous vehicle according to claim 1, wherein the algorithm evolution closed loop involves: achieving further evolution of the algorithm performance by adjusting hyperparameters of the learning algorithm and structural parameters of a neural network, and switching to the online learning closed loop of a next round.

5. The closed-loop online self-learning architecture applied to an autonomous vehicle according to claim 1, wherein the self-adversarial improvement closed loop involves: the autonomous vehicle operating in a real world and a virtual world simultaneously, jointly dealing with real and virtual traffic scenarios, which specifically comprises the following steps:
S1: determining, through a comprehensive evaluation of scenario task complexity and algorithm performance quantification, whether a current scenario exceeds an operational design domain of the automatic driving algorithm;
S2: performing parametric design on a scenario to obtain a parametric representation of scenario reconstruction;
S3: generating an adversarial scenario on the basis of an enhanced learning method or an adversarial learning method, and injecting the adversarial scenario into a virtual scenario generation library;
S4: combining the virtual scenario generation library, a typical standard data set, and real vehicle test data to form a data set library; and
S5: achieving an adversarial-enhanced data closed loop on the basis of the data set library by relying on a virtual and reality co-design.

6. The closed-loop online self-learning architecture applied to an autonomous vehicle according to claim 5, wherein the self-adversarial improvement closed loop closes data to a real vehicle operation level through an automatic scenario reconstruction technology and a data marking technology on the basis of characteristics of a real world and characteristics of virtual simulation;
the real world comprises collecting perception data and improving the performance of a perception algorithm, and at the same time, supplementing and enriching the data set library by identifying and capturing an edge scenario;
the virtual simulation is used for generating the adversarial scenario, and achieving better and reasonable responses by training an automatic driving decision-making and planning algorithm in real time;
in a framework of the self-adversarial improvement closed loop, an automatic driving system deals with more real-world scenarios by gradually and safely expanding the operational design domain thereof, and achieves real-time updates of virtual and real transparency until generation of virtual simulation scenarios is completely closed, thereby achieving the ultimate goal of safe automatic driving in the real world.

7. The closed-loop online self-learning architecture applied to an autonomous vehicle according to claim 1, wherein the cloud coevolution closed loop provides a multi-vehicle fast coevolution framework comprising a combined model training policy and a combined or local model update policy, thereby achieving efficient training resource sharing in the cloud coevolution.
